(19) United States
(12) Patent Application Publication
(10) Pub. No.: US 2007/0101326 A1
(43) Pub. Date: May 3, 2007

(54) Dynamic change of thread contention scope assignment

(75) Inventors: Weidong Cai, Cupertino, CA (US); Deepak Tripathi, Cupertino, CA (US); Sunil V. Rao, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/259,249

(22) Filed: Oct. 27, 2005

(51) Int. Cl. G06F 9/46

(52) U.S. Cl. 718/100

(57) ABSTRACT

A system and computer-implemented method of converting a contention scope attribute of a user thread executing in a multithreaded environment are described. The method includes dynamically converting the contention scope attribute of the user thread running in the multithreaded environment between a process scope and a system scope. In changing from system scope to process scope, the kernel thread to which the user thread is mapped is converted to a scheduler activation thread, the contention attribute for the user thread is reset in a threads library and the user thread is added to the run queue of a relevant virtual processor. In changing from process scope to system scope, the underlying scheduler activation kernel thread is permanently and exclusively mapped to the user thread to achieve a system scope for the thread. And a replacement scheduler activation kernel thread is created for other user threads of the same process previously sharing the original scheduler activation kernel thread.

### FIELD OF THE INVENTION

The present embodiments relate to dynamic change of thread contention scope assignment in a multithreaded environment.

### BACKGROUND

Traditional programming was sequential or serialized in fashion, with application code, i.e., a set of executable software instructions, executed one instruction after the next in a monolithic fashion, without regard for inefficient spending of numerous available system resources.

By decomposing processes executing in a multitasking environment into numerous semi-autonomous threads, thread programming has brought about a concurrent, or parallel, execution context, utilizing system resources more efficiently and with greater processing speed.

There are two major categories of threads, namely user threads and kernel threads. User level threads are created by runtime library routines. These threads are characterized by premium performance at lower costs, and the flexibility for custom utilization and tailored language support.

However, when user threads require access to system resources, such as when disk reads, input/output (I/O), and interrupt handling are required, the user level threads are mapped to kernel threads to perform such processing.

Threads have certain attributes, one specific attribute is referred to as the contention scope of the thread. Contention scope refers to how the user thread is mapped to the kernel thread, as defined by the thread model used in the user threads library.

A process contention scope specifies that a thread will be scheduled with respect to all other local contention scope threads for the same process. In particular, this means that there will be an M:1 mapping, where M is greater than 1, from multiple user threads to a single kernel thread, such that the user threads belonging to the same process contend for a single kernel thread.

On the other hand, system contention scope specifies that a thread will be scheduled against all other threads in the entire system. In particular, this means that there will be a 1:1 mapping from one user level thread to one kernel level thread, such that each user thread belonging to the same process has the same ability to acquire a kernel thread as any other thread or process in the entire system.

To date, the contention scope of a thread is created upon thread generation, with no ability to reset the contention scope by the user after the thread has been created. However, each type of contention scope, namely process contention scope and system contention scope, has relative advantages and disadvantages.

Even with system contention scope, user threads may rarely require system resources, so it may be wasteful to tie up precious and more costly kernel resources for every thread of each process. There is typically more context-switch overhead associated with system-scope threads than process-scope threads.

On the other hand, process contention scope threads may present other challenges for the user programmer. A program requiring significant system time may suffer from heavy blocking at the user level, as the numerous threads for a process contend for kernel resources. Such blocking results in degraded process execution and overall performance, especially where kernel resources are readily available with little burden by other executing applications.

### SUMMARY

The disclosed embodiments provide a computer-implemented method and system to dynamically convert thread contention scopes between process and system scopes in a multithreaded environment.

A computer-implemented method embodiment includes dynamically converting the contention scope attribute of the user thread running in the multithreaded environment between a process contention scope and a system contention scope. The conversion of the contention scope attribute is performed after the contention scope attribute is initially assigned. In changing from the system scope to the process scope, the kernel thread to which the user thread is mapped may be converted to a scheduler activation thread. The contention attribute for the converted user thread is reset in the threads library, and the converted user thread is added to the run queue of the relevant virtual processor for the process to which the user thread belongs. In changing from the process scope to the system scope, the user thread is permanently mapped to the underlying kernel scheduler activation thread and the scheduler activation thread is prevented from running other user threads of the same process, and thus achieve a system contention scope for the thread.

Still other advantages of the embodiments will become readily apparent to those skilled in the art from the following detailed description, wherein the preferred embodiments are shown and described, simply by way of illustration of the best mode contemplated of carrying out the embodiments. As will be realized, other and different embodiments are possible, and the details are capable of modifications in various obvious respects, all without departing from the scope of the embodiments.

### DESCRIPTION OF THE DRAWINGS

The present embodiments are illustrated by way of example, and not by limitation, in the figures of the accompanying drawings, wherein elements having the same reference numeral designations represent like elements throughout and wherein:

FIG. 1 is a high level block diagram of a computer system;

FIG. 2 is a block diagram depicting the execution context for a 1:1 thread model in accordance with certain embodiments;

FIG. 3 is a block diagram depicting the execution context for an M:1 thread model in accordance with certain embodiments;

FIG. 4 is a flow chart illustrating the steps in converting the contention scope of a user thread from a system contention scope to a process contention scope; and

FIG. 5 is a flow chart illustrating the steps in converting the contention scope of a user thread from a process contention scope to a system contention scope.

### DETAILED DESCRIPTION

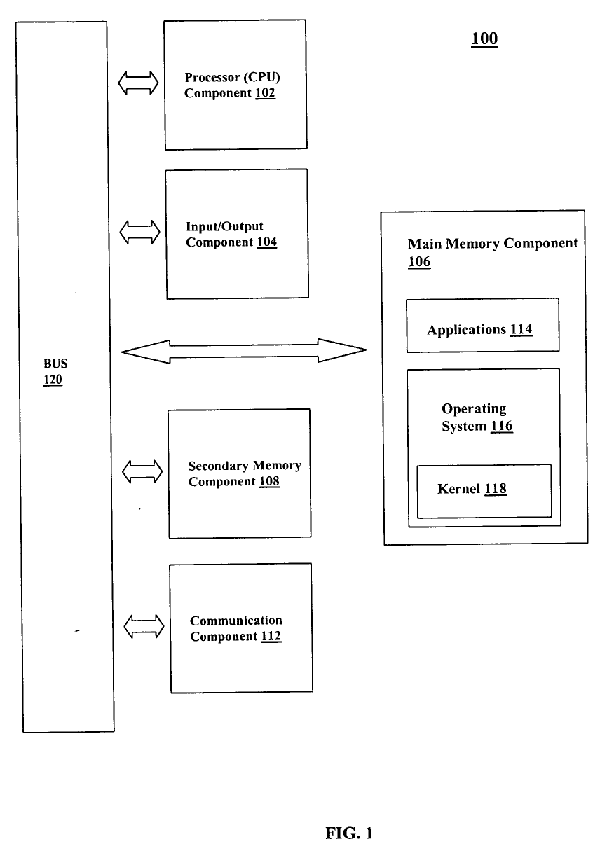

In accordance with a computer system as depicted in FIG. 1 on which an embodiment of the present invention may be used, a computer system 100 includes a processor (CPU) component 102, an input/output (I/O) component 104, a main memory component 106, a secondary memory component 108, and a communication component 112. An embodiment provides a computer-implemented method and system to dynamically convert thread contention scopes between process and system scope in a multithreaded environment. Specifically, CPU component 102 executes operating system instructions to dynamically convert a contention scope attribute of a user thread executing in the multithreaded environment between a process contention scope and a system contention scope.

CPU component 102 provides the processing engine for computer system 100. Comprising one or more processors and being connected to a communication bus 120, CPU component 102 executes one or more applications 114 stored in main memory component 106. In addition to executing applications 114 resident in main memory component 106, CPU component 102 may execute applications (also called computer programs, software or computer control logic) accessible from removable storage devices (such as secondary memory component 108), or through communication component 112.

I/O component 104 provides an interface for connecting an external device to computer system 100. Such devices may include a display device, a keyboard including alphanumeric and function keys, a pointing device, such as mouse, a video game controller, a microphone, a speaker, a scanner, a fax machine, etc.

Main memory component 106 comprises a random access memory (RAM) or other dynamic storage device coupled to bus 120 for storing data and instructions for execution by CPU component 102. Main memory component 106 includes applications 114 and an operating system 116. Operating system 116 controls system operation and allocation of system resources. Applications 114 are executed by processor component 102 and include calls to operating system 116 via program calls through an application programming interface (API). Operating system 116 also includes a kernel 118, a low layer of the operating system 116 including functionality required to schedule threads of an application 114 to CPU 102 for execution. Kernel 118 also implements system services, device driver services, network access, and memory management. Kernel 118 is the portion of operating system 116 with direct access to system hardware. Instructions comprising applications 114 may be read from or written to a computer-readable medium, as described below.

Secondary memory component 108 is a peripheral storage area providing long term storage capability. Secondary memory component 108 may include a disk drive, which may be magnetic, optical, or of another variety. Such a drive may read instructions from and write instructions to a computer-readable medium. Examples of the latter may include a floppy disk, a flexible disk, a hard disk, magnetic tape or any other magnetic medium, punch cards, paper tape, any other physical medium with patterns of holes, a random access memory (RAM), a programmable read only memory (PROM), an erasable PROM (EPROM), an electronically erasable PROM (EEPROM), a Flash-EPROM, any other memory chip or cartridge, a carrier wave embodied in electrical, electromagnetic, infrared or optical signal, or any other medium from which a computer can read.

Communication component 112 is an interface that allows software and data to be transferred between computer system 100 and external devices via a communication path. Examples of the interface include a standard or cable modem, a DSL connection, a network interface (such as an Ethernet card), a communication port, a local area network (LAN) connection, a wide area network (WAN) connection, and the like. Computer programs and data transferred via the interface are in the form of signals which can be electronic, electromagnetic, optical or the like.

Computer system 100 is a multiprogramming system, where applications 114 comprise multiple executing application programs in a multi-threaded environment. Each process in the program may comprise multiple threads, which may execute concurrently from each other and independently utilize system resources. Each process in this multi-threaded system is a changeable entity providing a basic executable unit and possessing attributes related to identifiers (for the process, the group of processes), the environment and working directory. Each process also provides a common address space and common system resources in relation to shared libraries, signal actions, file descriptors, and inter-process communication tools, including semaphores, pipes, message queues, and shared memory.

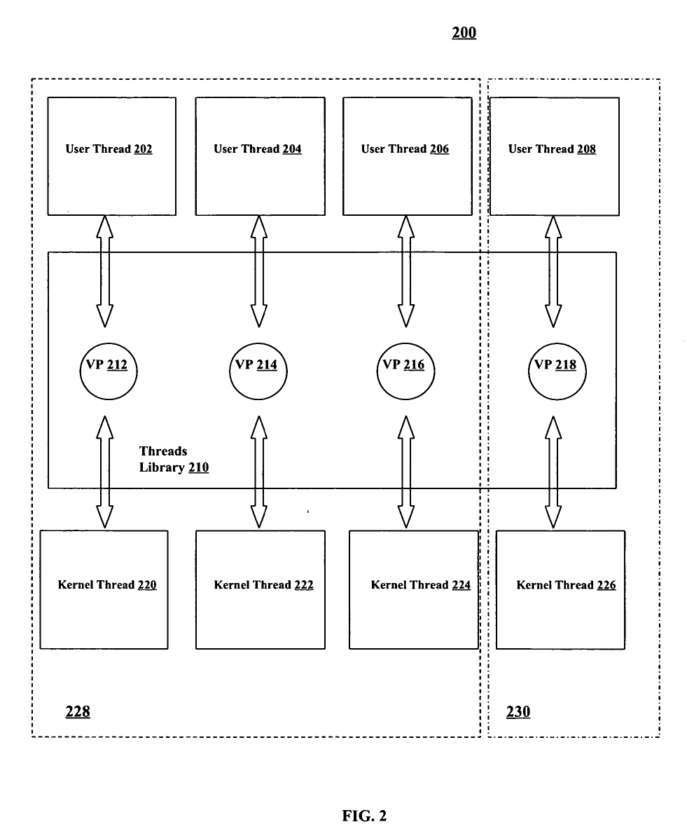

FIG. 2 is a block diagram depicting the execution context for a first 1:1 thread model 200 in accordance with the present embodiments. Thread model 200 includes user threads 202, 204, 206, 208, threads library 210 (including virtual processors 212, 214, 216, 218), and kernel threads 220, 222, 224, 226.

As depicted in FIG. 2, a first process 228 (dashed line) of computer system 100 comprises three user threads 202, 204, 206 and corresponding kernel threads 220, 222, 224 while a second process 230 (dash-dot line) comprises a single user thread 208 and corresponding kernel thread 226. Each thread is a sequence of instructions comprising a schedulable entity executable in parallel with other threads. Accordingly, the illustrated group of threads are not each an individual process, but rather smaller portions of a single process executed concurrently by processor component 102 (FIG. 1).

Each of threads 202-208, and 220-226, are schedulable entities, possessing properties required for independent control, including properties relating to a stack, thread-specific information, pending and blocked signals, and notably scheduling properties, such as for example, policy or priority properties. The threads are subportions of a single process, e.g., first process 228 and second process 230, and concurrently (or in parallel) function to comprise the process. Accordingly, the threads exist within the context of a single process, and cannot reference threads in another process.

The threads are part of a single process and share the same address space, such that multiple pointers having the same value in different threads refer to the same memory data. Shared resources are similarly specific to threads within a single process, so that if any thread changes a shared system resource, all threads within the process are affected. The threads may have three main scheduling parameters, namely (i) policy, defining how the scheduler treats the thread once executed by the CPU 102, (ii) contention scope, as defined by the thread model used in the threads library, as described in greater detail below, and (iii) priority, providing the relative importance of the work being performed by a given thread.

User threads 202-208 are entities used by programmers to handle multiple flows of control within an application. In an embodiment, the threads are Portable Operating System Interface (POSIX) threads, as defined by Institute for Electrical and Electronics Engineers (IEEE) standard 1033. The application programming interface for handling user threads is provided by a runtime library resident in main memory component 106 called the threads library. In an embodiment, the library is the POSIX threads library, commonly referred to as the pthreads library.

User threads 202-208 are executed in the local programming runtime environment, where programs are, for example, compiled into object code, the object code is linked together, and program execution is performed locally. Here, user threads 202-208 are managed by the runtime library routines linked into each application, so that thread management operations may not require any use of kernel 118, referred to as kernel intervention. User threads 202-208 provide the benefit of strong performance at low cost, with the cost of user thread operations being within an order of magnitude of the cost of a procedure call, and flexibility, offering the ability for language based and user preferred customization without modification of kernel 118.

However, user threads 202-208 may require access to and execution of kernel 118 if any system resources are required. Examples of system resources being required are disk read operations, interrupt handling, I/O requests, page faults, and the like. Where these “real world” operating system activities are required, user threads 202-208 are mapped to kernel threads 220-226.

As depicted in FIG. 2, in system 200 user threads 202-208 are respectively mapped to kernel threads 220-226 by individual virtual processors (VPs) 212-218 of threads library 210. As their name denotes, VPs 212-218 function similarly to a processor such as processor component 102 in that they execute scheduled user threads 202-208 on kernel threads 220-226. VPs 212-218 are threads library 210 entities that are implicitly defined by the type of library used. In threads library 210, VPs 212-218 are structures bound to kernel threads 220-226.

Kernel threads 220-226 perform kernel-specific operations for computer system 100, including the foregoing disk read operations, interrupt handling, I/O requests, page faults, etc. Kernel threads 220-226 are light-weight processes (LWPs), i.e., a set of entities scheduled by kernel 118, whether such entities are threads or processes transmitted for processing.

Threads library 210 sets the contention scope of user threads 202-208 at the time of thread creation. The contention scope defines how user threads 202-208 are mapped to kernel threads 220-226. Computer system 200 depicts a one-to-one (1:1) mapping model, where each user thread 202-208 is mapped to a respective kernel thread 220-226. In this mapping model, each user thread 202-208 is mapped to VP 212-218, respectively. The kernel threads to which the user thread maps handle user thread programming operations defined by the threads library 210.

Operating system 116 directly schedules user threads 202-208 to respective kernel threads 220-226. Accordingly, the kernel-scheduled threads compete with each other, as well as, other threads on computer system 100 for processing time from processor component 102, rather than competing solely with intraprocess threads, i.e., user threads within the same process. Therefore, the threads of computer system 100, having the mapping attributes depicted therein (1:1 mapping) and described above, are referred to as having system contention scope. Threads library 210 sets the thread attribute for system contention scope mapping at thread creation time. However, system scope threads present a number of associated problems, in that in comparison to user processing, kernel resources are more costly due to greater protection boundaries, perform more poorly due to greater system level operational demands, etc.

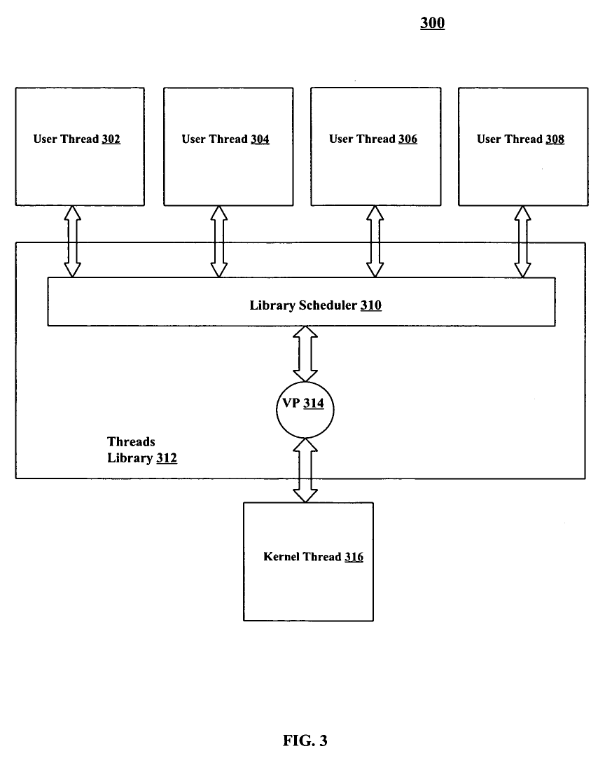

FIG. 3 is a block diagram depicting the execution context for a M:1 mapping model 300 in accordance with an embodiment. Mapping model 300 includes user threads 302, 304, 306, 308, threads library 312 (including library scheduler 310, virtual processor 314), and kernel thread 316.

Threads 302-308 of mapping model 300 are referred to as having process contention scope. Mapping model 300 is referred to as an M:1 model, or library model, because threads 302-308 of the same process are mapped to the same single kernel thread 316. In particular, all user threads 302-308 are mapped to a single kernel thread 316 belonging to their process. Therefore, all user threads 302-308 are scheduled by library scheduler 310 and VP 314 executes each thread in turn.

In an embodiment, library scheduler 310 of the threads library 312 performs the M:1 mapping. Such library-scheduled user threads 302-308 are referred to as process contention scope threads because each thread competes for processing time of processor component 102 only with other threads from the same process, namely user threads 302-308. Because there is only a single light weight process (LWP), i.e., kernel thread 316, the kernel thread is switched between the user threads during execution in an operation called context switching.

Process contention scope threads 302-308 of FIG. 3 have the advantage of higher performance at lower consumption of system resources. However, if a program is compute intensive, the overall system performance will suffer. This is particularly the case where kernel resources are readily available and have little burden from other executing applications.

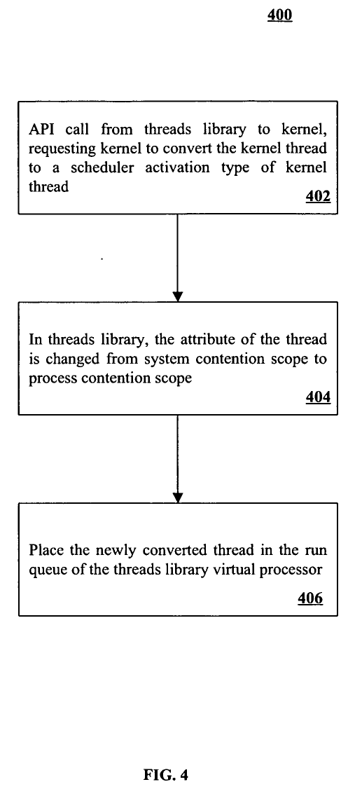

FIG. 4 depicts a flow chart 400 of the steps for converting the contention scope of a user thread from a system contention scope to a process contention scope. As described above, with respect to FIG. 2 the contention scope of user threads 202-208 are initially set to either system scope or process scope by the threads library 210 during initial generation of the user threads. The FIG. 4 flow chart depicts a dynamic mechanism for conversion of user threads 202-208 from system contention scope to process contention scope after the user threads have been generated.

In step 402, a user thread 202 (shown in FIG. 2) invokes a contention scope conversion routine. The contention scope conversion routine is executed by computer system 100 and invokes threads library 210 to register the request with kernel 118.

In addition, the conversion routine causes one or more application programming interface (API) calls between the threads library 210 and kernel 118. In response to the conversion routine invocation of an API to kernel 118, the kernel changes the one-to-one association between the user level thread, for example user thread 202, and the corresponding kernel thread, for example kernel thread 220. In an embodiment, the relevant kernel thread 220, to which user thread 202 is mapped, is modified to a scheduler activation type of kernel thread.

Scheduler activation refers to an execution context used in a multithreaded environment for executing user-level threads in the same manner as a standard LWP (or kernel thread), except at events such as blocked or unblocked in kernel. In case of these events, the library scheduler 310 is free to reschedule user threads on any scheduler activation. The number of executing scheduler activations allocated to the process remains unchanged throughout the process' life.

The benefit of changing the kernel thread 220 to a scheduler activation type of kernel thread in the context of the present embodiments is that the scheduler activation context permits different user threads to be executed on a single kernel thread at potentially different times. Accordingly, the one-to-one mapping, or association, between the user thread 202 and the kernel thread 220 is no longer valid, and execution of user thread 202 no longer impels kernel thread 220 execution; user thread 202 can run on other scheduler activations.

Upon completion of step 402, or concurrently therewith in certain embodiments, the flow of control proceeds to step 404 and threads library 210 changes the contention attribute of user thread 202. In particular, the contention scope attribute of the thread is changed in the threads library 210 from a system contention scope to a process contention attribute. Because threads library 210 generates and maintains user threads 202-208, the threads library changes the attribute of the user thread. The flow of control proceeds to step 406.

In step 406, the newly converted user thread 202 is added to the run queue of a relevant virtual processor. As noted above, in the 1:1 mapping model of FIG. 2, VPs 212-218 provide a one-to-one mapping of the user threads to the kernel threads. In this step, the newly converted user thread having a process contention scope attribute is added to an appropriate run queue, for example, of a VP or a global run queue. In fact, there may be several different VPs, each having associated run queues. There may also be a global run queue, which handle threads having higher priorities, requiring, for example, real-time processing. When a user thread is to be scheduled for processing by the VP, which handles the underlying thread process, the library scheduler first checks the global run queue, next the VP run queue, and schedules the thread appropriately. The result is the addition of the user thread to a model configuration as illustrated in FIG. 3, with the user thread being added, for example, to the run queue of VP 314 to which other user threads 302-308 of the same process already belong.

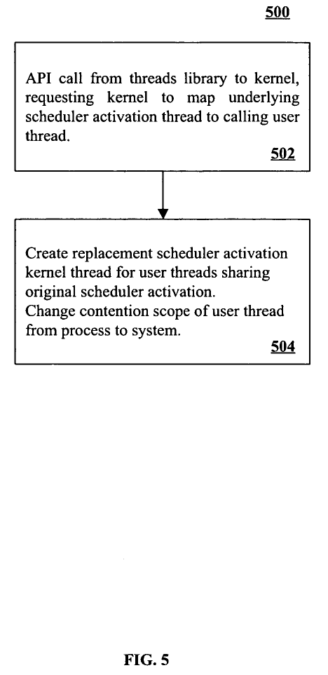

FIG. 5 depicts a flow chart 500 of the steps for converting the contention scope of a user thread from a process contention scope to a system contention scope. Here again, the flow chart of FIG. 5 provides a dynamic mechanism for conversion of user threads 202-208 from process contention scope to system contention scope after the user threads have already been generated and their contention scopes initially assigned.

With reference to FIG. 3, in step 502, an exemplary user thread 302 invokes the contention scope conversion routine. The contention scope conversion routine invokes threads library 312 to register the request to kernel 118.

In addition, in step 502 the underlying scheduler activation is instructed to map to the user thread 302, and to refrain from running any other user threads, until it is desired for the user thread, through a process described herein, to change its mapping back to its original state or it is desired for the user thread to be terminated. Referring to FIG. 3, the API calls from threads library 312 and kernel 118 requests kernel thread 316 to be modified to a scheduler activation type kernel thread.

Also, in step 502, threads library 312 makes one or more API calls to emulate a replacement scheduler activation. When scheduler activation is used in computer system 100, a user thread 302 requiring system resources invokes kernel 118 for such system processing. This call, referred to as a system call, has the effect of blocking in kernel thread 316, because the kernel may not be concurrently used by other contending user threads 304-308, resulting in prevention of the execution of other user threads 304-308 in the same process.

To alleviate the blocking problem, a replacement scheduler activation thread is created when such system calls are made. The role of the replacement scheduler activation thread is to provide kernel access for remaining user threads 304-308. In the present embodiments, the foregoing API calls provide a method to (i) prevent other threads from soliciting the same scheduler activation kernel thread, and (ii) automatically generate the replacement scheduler activation thread, without requiring that any user threads be blocked. The result is that remaining user threads 304-308 are provided kernel access by the replacement scheduler activation thread, similar to the kernel access provided by kernel thread 316.

It will be readily seen by one of ordinary skill in the art that the embodiments fulfills one or more of the advantages set forth above. After reading the foregoing specification, one of ordinary skill will be able to affect various changes, substitutions of equivalents and various other aspects of the embodiments as broadly disclosed herein. It is therefore intended that the protection granted hereon be limited only by the definition contained in the appended claims and equivalents thereof.

What is claimed is:

1. A computer-implemented method of converting a contention scope attribute of a user thread executing in a multithreaded environment, comprising:
dynamically converting the contention scope attribute of the user thread executing in the multithreaded environment from a system contention scope to a process contention scope,
wherein the system contention scope defines the user thread as being mapped in a 1:1 manner to a kernel thread, and
wherein the process contention scope defines the user thread as being mapped in an M:1 manner to a scheduler activation kernel thread, wherein M is greater than 1.

2. A computer-implemented method as claimed in claim 1, further comprising changing the kernel thread to a scheduler activation type of kernel thread.

3. A computer-implemented method as claimed in claim 1, further comprising changing the association between the user thread and the kernel thread to which the user thread is mapped.

4. A computer-implemented method as claimed in claim 3, wherein said association is changed from a 1:1 association between the user thread and the kernel thread to an M:1 association between the user thread and the scheduler activation kernel thread, where M is greater than 1.

5. A computer-implemented method as claimed in claim 1, further comprising changing, in a user threads library, the contention scope attribute of the user thread from a system contention scope to a process contention scope.

6. A computer-implemented method as claimed in claim 5, wherein the user threads library is configured to create and manage the user thread and other user threads.

7. A computer-implemented method as claimed in claim 1, further comprising reassigning a scheduling responsibility for the user thread from a kernel level to a user level.

8. A computer-implemented method as claimed in claim 7, wherein the user thread is added to a run queue related to the process to which the user thread belongs.

9. A computer-implemented method as claimed in claim 8, wherein the run queue is related to any virtual processor of the process.

10. A computer-implemented method of converting a contention scope attribute of a user thread executing in a multithreaded environment, comprising:
dynamically converting the contention scope attribute of the user thread executing in the multithreaded environment from a process contention scope to a system contention scope,
wherein the system contention scope defines the user thread as being mapped in a 1:1 manner to a kernel thread, and
wherein the process contention scope defines the user thread as being mapped in an M:1 manner to a scheduler activation kernel thread, wherein M is greater than 1.

11. A computer-implemented method as claimed in claim 10, wherein said scheduler activation kernel thread is protected from contention by additional user threads belonging to the same process, to provide the user thread a system contention scope.

12. A computer-implemented method as claimed in claim 11, wherein the user thread makes an application programming interface call to invoke the conversion.

13. A computer-implemented method as claimed in claim 12, further comprising a system call made from the user thread to generate a replacement scheduler activation.

14. A computer system, comprising:
a processor for receiving and transmitting data;
a memory coupled to said processor, said memory having stored therein sequences of instructions which, when executed by said processor, cause said processor to dynamically convert the contention scope attribute of a user thread executing thereon from a process contention scope to a system contention scope, wherein said conversion is performed after the contention scope attribute is initially assigned.

15. A computer-readable medium, comprising:
at least one sequence of machine instructions in machine form, wherein execution of the instructions by a computer causes the computer to:
dynamically convert the contention scope attribute of the user thread executing in the multithreaded environment from a process contention scope to a system contention scope, wherein said conversion is performed after the contention scope attribute is initially assigned.
